(19) United States
(12) Patent Application Publication
(10) Pub. No.: US 2020/0167863 A1
(43) Pub. Date: May 28, 2020

(54) Method and System for Determining a Supplemental Credit Metric

(71) Applicant: Visa International Service Association, San Francisco, CA (US)

(72) Inventors: Sachin Cherian Mathew, Singapore (SG); Minhui Zhu, Singapore (SG); Kathrina Rose Denila Ondap, Singapore (SG); Shi Kai Khiew, Singapore (SG); Alexis Kristoffer Soriao Antiola, Singapore (SG); Robin Kedia, Singapore (SG); Melanie Dow, Singapore (SG)

(21) Appl. No.: 16/629,121

(22) PCT Filed: Jul. 7, 2017
(86) PCT No.: PCT/US2017/041052

§ 371 Date: Jan. 7, 2020

(51) Int. Cl. G06Q 40/02; G06Q 20/40

(52) U.S. Cl. CPC G06Q 40/025; G06Q 20/4014

(57) ABSTRACT

A method of determining a supplemental credit metric based on transaction data of a user including: receiving user transaction data including transaction parameters; determining a supplemental credit metric of the user based on the transaction parameters; receiving a request message; determining information identifying the user based on the request message; determining information corresponding to the supplemental credit metric of the user; and communicating the information corresponding to the supplemental credit metric of the user to a computing device. A system of determining a supplemental credit metric based on transaction data of a user is also disclosed.

### BACKGROUND OF THE INVENTION

### Field of the Invention

This invention relates to determining a supplemental credit metric and, in one particular embodiment or aspect, to a method and system for determining a supplemental credit metric based on transaction data of a user.

### Description of Related Art

Lenders, such as banks and credit card companies use credit scores to evaluate the potential risk associated with lending money to an applicant. A more creditworthy applicant is a more desirable applicant to loan money based on the expected lower risk of that applicant defaulting on the loan.

Each country has different entities, such as credit bureaus, that collect information regarding each applicant's credit history and provide credit scores based on that history. These entities generally receive their information from limited sources, which include domestic banks, mobile phone companies, insurance companies, property owners, and government departments. These entities do not have access to individual transactions of the applicant using the applicant's portable financial device (e.g., credit card).

Since each country has separate entities that review limited information, an applicant moving from a first country to a second country starts with a blank credit history, even if their credit history in the first country was excellent and well-established. Thus, this historically creditworthy applicant encounters difficulty getting approved for favorable loans, credit cards, and other transaction activity. This applicant is disadvantaged merely based on a relocation and the lender is disadvantaged by a missed opportunity to provide a loan to a creditworthy applicant.

As previously mentioned, credit bureaus only review a limited amount of information to generate their credit scores for applicants. Information associated with the applicant's individual transactions using credit cards is not included; however, this information may also be indicative of the applicant's creditworthiness. Thus, credit scores, as currently determined by credit bureaus, do not utilize all information useful to determine an applicant's creditworthiness. In addition, applicants do not have easy access to their credit score and cannot track a credit score that considers their individual transactions using credit cards, which may be helpful to them in tracking their overall credit worthiness.

Accordingly, there is a need in the art to provide applicants, lenders, and other entities a supplemental credit metric that considers individual transactions, allows the applicant to maintain an indication of their creditworthiness in the event of a relocation to a different country or region, and, overall, provides a more complete overview of the applicant's creditworthiness.

### SUMMARY OF THE INVENTION

Accordingly, generally provided is an improved method and system of determining a supplemental credit metric based on transaction data of a user.

According to a non-limiting embodiment or aspect, provided is a method of determining a supplemental credit metric based on transaction data of a user including: receiving, with at least one processor, user transaction data including transaction parameters associated with transactions initiated with a portable financial device of a user; determining, with at least one processor, a supplemental credit metric of the user based at least partially on the transaction parameters; receiving, with at least one processor, a request message, with the request message including information associated with the user; determining, with at least one processor, information identifying the user based on the information included in the request message; determining, with at least one processor, information corresponding to the supplemental credit metric of the user; and communicating, with at least one processor, the information corresponding to the supplemental credit metric of the user to a computing device.

In one non-limiting embodiment or aspect, the request message may be received from the computing device. The request message may be a transaction authorization request for a transaction initiated with the portable financial device of the user. The information corresponding to the supplemental credit metric of the user may be communicated to the computing device upon initiation of a transaction by the user using the portable financial device. The request message may be received from the computing device, and the computing device may be associated with an issuer in the first region, and the portable financial device of the user was issued by or on behalf of an issuer outside the first region.

In one non-limiting embodiment or aspect, the method may further include generating, with at least one processor, a credit score corresponding to the user; generating, with at least one processor, a revised credit score based at least partially on the credit score and the supplemental credit metric. The credit score corresponding to the user may not be generated based on the transaction parameters. The credit score corresponding to the user may not be generated based on individual transactions initiated with the portable financial device of the user. The method may further include generating a credit score corresponding to the user based at least partially on the supplemental credit metric.

In one non-limiting embodiment or aspect, the method may further include at least one of generating and communicating a product or service recommendation to the computing device based at least partially on the supplemental credit metric. The product or service recommendation may be generated based at least partially on a product or service used by users having a similar supplemental credit metric. The method may further include initiating a transaction activity based at least partially on the supplemental credit metric. The method may further include initiating a target activity based at least partially on the supplemental credit metric.

According to another non-limiting embodiment or aspect, provided is a system of determining a supplemental credit metric based on transaction data of a user including at least one server computer including at least one processor, the at least one server computer programmed and/or configured to: receive user transaction data including transaction parameters associated with transactions initiated with a portable financial device of a user; determine a supplemental credit metric of the user based at least partially on the transaction parameters; receive a request message, with the request message including information associated with the user; determine information identifying the user based on the information included in the request message; determine information corresponding to the supplemental credit metric of the user; and communicate the information corresponding to the supplemental credit metric of the user to a computing device.

In one non-limiting embodiment or aspect, the request message may be received from the computing device. The request message may be a transaction authorization request for a transaction initiated with the portable financial device of the user. The information corresponding to the supplemental credit metric of the user may be communicated to the computing device upon initiation of a transaction by the user using the portable financial device. The request message may be received from the computing device, and the computing device may be associated with an issuer in the first region, and the portable financial device of the user was issued by or on behalf of an issuer outside the first region.

In one non-limiting embodiment or aspect, the at least one server computer may be further programmed and/or configured to: generate a credit score corresponding to the user; generate a revised credit score based at least partially on the credit score and the supplemental credit metric. The credit score corresponding to the user may not be generated based on the transaction parameters. The credit score corresponding to the user may not be generated based on individual transactions initiated with the portable financial device of the user. The at least one server computer may be further programmed and/or configured to generate a credit score corresponding to the user based at least partially on the supplemental credit metric.

In one non-limiting embodiment or aspect, the at least one server computer may be further programmed and/or configured to generate and/or communicate a product or service recommendation to the computing device based at least partially on the supplemental credit metric. The product or service recommendation may be generated based at least partially on a product or service used by users having a similar supplemental credit metric. The at least one server computer may be further programmed and/or configured to initiate a transaction activity based at least partially on the supplemental credit metric. The at least one server computer may be further programmed and/or configured to initiate a target activity based at least partially on the supplemental credit metric.

According to another non-limiting embodiment or aspect, provided is a method of determining a supplemental credit metric based on transaction data of a user including: receiving, with at least one processor, user transaction data including transaction parameters associated with transactions initiated with a plurality of portable financial devices of a user, where at least two of the portable financial devices were issued by or on behalf of issuers in different regions from one another; determining, with at least one processor, a supplemental credit metric of the user based at least partially on the transaction parameters; receiving, with at least one processor, a request message from a computing device, the request message associated with the user; and communicating, with at least one processor, the supplemental credit metric of the user to the computing device.

Further non-limiting embodiments or aspects will now be set forth in the following numbered clauses.

Clause 1: A method of determining a supplemental credit metric based on transaction data of a user, comprising: receiving, with at least one processor, user transaction data comprising transaction parameters associated with transactions initiated with a portable financial device of a user; determining, with at least one processor, a supplemental credit metric of the user based at least partially on the transaction parameters; receiving, with at least one processor, a request message, wherein the request message comprises information associated with the user; determining, with at least one processor, information identifying the user based on the information included in the request message; determining, with at least one processor, information corresponding to the supplemental credit metric of the user; and communicating, with at least one processor, the information corresponding to the supplemental credit metric of the user to a computing device.

Clause 2: The method of clause 1, wherein the request message is received from the computing device.

Clause 3: The method of clause 1 or 2, wherein the request message is a transaction authorization request for a transaction initiated with the portable financial device of the user.

Clause 4: The method of any of clauses 1-3, wherein the information corresponding to the supplemental credit metric of the user is communicated to the computing device upon initiation of a transaction by the user using the portable financial device.

Clause 5: The method of any of clauses 1-4, wherein the request message is received from the computing device, wherein the computing device is associated with an issuer in the first region, wherein the portable financial device of the user was issued by or on behalf of an issuer outside the first region.

Clause 6: The method of any of clauses 1-5, further comprising: generating, with at least one processor, a credit score corresponding to the user; and generating, with at least one processor, a revised credit score based at least partially on the credit score and the supplemental credit metric.

Clause 7: The method of any of clauses 1-6, wherein the credit score corresponding to the user is not generated based on the transaction parameters.

Clause 8: The method of any of clauses 1-7, wherein the credit score corresponding to the user is not generated based on individual transactions initiated with the portable financial device of the user.

Clause 9: The method of any of clauses 1-8, further comprising generating a credit score corresponding to the user based at least partially on the supplemental credit metric.

Clause 10: The method of any of clauses 1-9, further comprising at least one of generating and communicating a product or service recommendation to the computing device based at least partially on the supplemental credit metric.

Clause 11: The method of any of clauses 1-10, wherein the product or service recommendation is generated based at least partially on a product or service used by users having a similar supplemental credit metric.

Clause 12: The method of any of clauses 1-11, further comprising initiating a transaction activity based at least partially on the supplemental credit metric.

Clause 13: The method of any of clauses 1-12, further comprising initiating a target activity based at least partially on the supplemental credit metric.

Clause 14: A system of determining a supplemental credit metric based on transaction data of a user, comprising at least one server computer including at least one processor, the at least one server computer programmed and/or configured to: receive user transaction data comprising transaction parameters associated with transactions initiated with a portable financial device of a user; determine a supplemental credit metric of the user based at least partially on the transaction parameters; receive a request message, wherein the request message comprises information associated with the user; determine information identifying the user based on the information included in the request message; determine information corresponding to the supplemental credit metric of the user; and communicate the information corresponding to the supplemental credit metric of the user to a computing device.

Clause 15: The system of clause 14, wherein the request message is received from the computing device.

Clause 16: The system of clause 14 or 15, wherein the request message is a transaction authorization request for a transaction initiated with the portable financial device of the user.

Clause 17: The system of any of clauses 14-16, wherein the information corresponding to the supplemental credit metric of the user is communicated to the computing device upon initiation of a transaction by the user using the portable financial device.

Clause 18: The system of any of clauses 14-17, wherein the request message is received from the computing device, wherein the computing device is associated with an issuer in the first region, wherein the portable financial device of the user was issued by or on behalf of an issuer outside the first region.

Clause 19: The system of any of clauses 14-18, wherein the at least one server computer is further programmed and/or configured to: generate a credit score corresponding to the user; and generate a revised credit score based at least partially on the credit score and the supplemental credit metric.

Clause 20: The system of any of clauses 14-19, wherein the credit score corresponding to the user is not generated based on the transaction parameters.

Clause 21: The system of any of clauses 14-20, wherein the credit score corresponding to the user is not generated based on individual transactions initiated with the portable financial device of the user.

Clause 22: The system of any of clauses 14-21, wherein the at least one server computer is further programmed and/or configured to generate a credit score corresponding to the user based at least partially on the supplemental credit metric.

Clause 23: The system of any of clauses 14-22, wherein the at least one server computer is further programmed and/or configured to generate and/or communicate a product or service recommendation to the computing device based at least partially on the supplemental credit metric.

Clause 24: The system of any of clauses 14-23, wherein the product or service recommendation is generated based at least partially on a product or service used by users having a similar supplemental credit metric.

Clause 25: The system of any of clauses 14-24, wherein the at least one server computer is further programmed and/or configured to initiate a transaction activity based at least partially on the supplemental credit metric.

Clause 26: The system of any of clauses 14-25, wherein the at least one server computer is further programmed and/or configured initiate a target activity based at least partially on the supplemental credit metric.

Clause 27: A method of determining a supplemental credit metric based on transaction data of a user, comprising: receiving, with at least one processor, user transaction data comprising transaction parameters associated with transactions initiated with a plurality of portable financial devices of a user, wherein at least two of the portable financial devices were issued by or on behalf of issuers in different regions from one another; determining, with at least one processor, a supplemental credit metric of the user based at least partially on the transaction parameters; receiving, with at least one processor, a request message from a computing device, the request message associated with the user; and communicating, with at least one processor, the supplemental credit metric of the user to the computing device.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments or aspects that are illustrated in the accompanying schematic figures, in which:

FIG. 1 is a schematic diagram of one non-limiting embodiment or aspect of a system of determining a supplemental credit metric based on transaction data of a user according to principles of the present invention;

FIG. 2 is a schematic diagram of one non-limiting embodiment or aspect of another system of determining a supplemental credit metric based on transaction data of a user according to principles of the present invention;

FIG. 3 is a step diagram of one non-limiting embodiment or aspect of a method of determining a supplemental credit metric based on transaction data of a user according to principles of the present invention;

FIG. 4 is a step diagram of one non-limiting embodiment or aspect of another method of determining a supplemental credit metric based on transaction data of a user according to principles of the present invention;

FIG. 5 is a sequence diagram of one non-limiting embodiment or aspect of a method of determining a supplemental credit metric based on transaction data of a user according to principles of the present invention;

FIG. 6 is a sequence diagram of one non-limiting embodiment or aspect of another method of determining a supplemental credit metric based on transaction data of a user according to principles of the present invention;

FIG. 7 is a table of one non-limiting embodiment or aspect of product recommendations based on a supplemental credit metric according to principles of the present invention;

FIG. 8 is a table of one non-limiting embodiment or aspect of service recommendations based on a supplemental credit metric according to principles of the present invention; and

FIG. 9 is a table of one non-limiting embodiment or aspect of user portable financial device history according to principles of the present invention.

### DETAILED DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the terms “issuing institution,” “portable financial device issuer,” “issuer,” or “issuer bank” may refer to one or more entities that provide accounts to customers for conducting payment transactions, such as initiating credit and/or debit payments. For example, an issuing institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases, such that they may be used to conduct a transaction without directly using the original account identifier. In some examples, an original account identifier, such as a PAN, may be associated with a plurality of tokens for different individuals or purposes. An issuing institution may be associated with a bank identification number (BIN) that uniquely identifies it. The terms “issuer” and “issuer server” may also refer to one or more computer systems operated by or on behalf of an issuing institution, such as a server computer executing one or more software applications. For example, an issuer system may include one or more authorization servers for authorizing or effecting a payment transaction.

As used herein, the term “merchant” refers to an individual or entity that provides goods and/or services, or access to goods and/or services, to customers (also referred to herein as a “consumer”) based on a transaction, such as a payment transaction. “Merchant” or “merchant server” may also refer to one or more computer systems operated by or on behalf of a merchant, such as a server computer executing one or more software applications. As used herein, a “merchant system” may refer to one or more computers and/or peripheral devices used by a merchant to engage in or facilitate payment transactions with customers, including one or more point-of-sale (POS) devices, one or more card readers, near-field communication (NFC) receivers, RFID receivers, and/or other contactless transceivers or receivers, contact-based receivers, payment terminals, computers, servers, input devices, and/or other like devices that may be used to initiate, facilitate, or process a payment transaction. A merchant system may also include one or more server computers programmed and/or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer. The term “transaction service provider” may also refer to one or more computer systems operated by or on behalf of a transaction service provider, such as a server computer executing one or more software applications (“transaction processing server”, e.g., VisaNet). The term “transaction processing server” (or system) may include one or more computers, processors, storage devices, databases, network interfaces, and executable instructions or code in the form of applications, APIs, software, firmware, code modules and the like operating in a network environment. When a user engages or initiates a transaction with a merchant at a point-of-sale, he or she will interact with a point-of-sale system, e.g., using a credit card, portable financial device, payment device, and/or mobile device to interact either directly or indirectly with a reader device communicating as or within the point-of-sale system.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information, such as an account identifier or a name of the account holder. As used herein, the information or data associated with the “portable financial device” may be used to conduct electronic or online transactions with one or more merchants, such as through an online location of the merchant.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “credit bureau” may refer to an entity that collects and/or maintains user credit information and generates credit reports and credit scores of the users based on the credit information collected. The term “credit bureau” may also refer to a credit bureau system including one or more computers, processors, storage devices, network interfaces, and executable instructions or code in the form of applications, APIs, software, firmware, code modules, and the like operating in a network environment.

As used herein, the term “financial institution” may refer to an entity that provides financial services to users. The financial institution may be an issuer. The financial institution may issue, credit cards and/or loans, including mortgages, to users based on user creditworthiness. The financial institution my determine the user creditworthiness based at least in part on credit information, including credit scores and credit reports of the user. Non-limiting examples of financial institutions include banks, credit unions, mortgage loan institutions, mortgage brokerage firms, lending institutions, and the like. The term “financial institution” may also refer to a system including one or more computers, processors, storage devices, network interfaces, and executable instructions or code in the form of applications, APIs, software, firmware, code modules and the like operating in a network environment.

As used herein, the term “server” may refer to or include one or more processors or computers, storage devices, or similar computer arrangements that are operated by, or facilitate communication and processing for, multiple parties in a network environment, such as the internet, although it will be appreciated that communication may be facilitated over one or more public or private network environments and that various other arrangements are possible. Further, multiple computers, e.g., servers or other computerized devices, e.g., point-of-sale devices, directly or indirectly communicating in the network environment may constitute a “system,” such as a merchant system.

Non-limiting embodiments or aspects of the present invention are directed to a method and system of determining a supplemental credit metric based on transaction data of a user. Non-limiting embodiments or aspects of the present invention allow for users of portable financial devices to receive a supplemental credit metric which supplements their credit score determined using traditional methods by analyzing individual transactions of the user using their portable financial device. The transaction processing server processor may determine the supplemental credit metric by analyzing portable financial device transactions, regardless of the location of the issuer bank of the portable financial device, meaning no geographical restrictions are imposed on the determination of the supplemental credit metric. This feature of the present invention allows users of portable financial device to maintain an indication of their creditworthiness even if they are relocating from a first region or country to a second region or country. This further benefits lending institutions by providing them with a more accurate representation of an applicant's creditworthiness, including applicants who are historically creditworthy but would otherwise have a blank credit score based on a recent relocation from the first region or country to the second region or country. Non-limiting embodiments or aspects of the invention allow users to more closely track their supplemental credit metric without adverse effects on that supplemental credit metric. For example, the transaction processing server processor may communicate the information regarding the user's supplemental credit metric to the user's computing device to update the user on their supplemental credit metric, such as periodically or in response to a purchase by the user using their portable financial device. The transaction processing server may also communicate target activities, such as offers, to the user's computing device based on their supplemental credit metric. In this way, users receive offers relevant to them based on their supplemental credit metric.

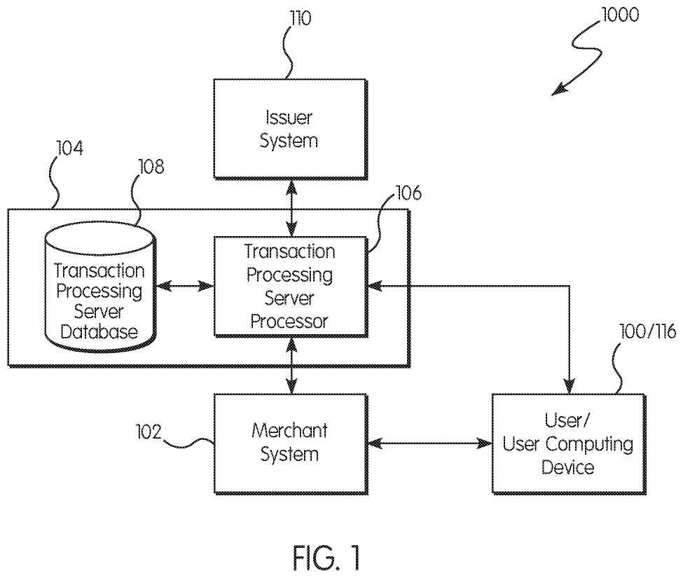

Referring to FIG. 1, a non-limiting embodiment or aspect of a system 1000 of determining a supplemental credit metric based on transaction data of a user 100 is shown. The user 100 may be a holder of a portable financial device (e.g., an account holder) and use that portable financial device associated with a transaction service provider (TSP) and issued by an issuer. The user 100 may use the portable financial device to initiate transactions with a merchant having a merchant system 102, which may include a merchant point-of-sale (POS) device. In some non-limiting embodiments or aspects, the user 100 may purchase goods or services from the merchant using the portable financial device and the merchant system 102 to guarantee payment of the goods or services.

With continued reference to FIG. 1, the transaction service provider may have a transaction processing server 104 operated by or on behalf of the transaction service provider. The transaction processing server 104 may include a transaction processing server processor 106 and a transaction processing server database 108. It will be appreciated that the transaction processing server 104 may include further computers, processors, databases, and the like. Further, the transaction processing server processor 106 may include a single processor or multiple processors, and the transaction processing server database 108 may be a single database or multiple databases.

With continued reference to FIG. 1, the merchant system 102 may communicate with the transaction processing server processor 106 to initiate further processing of a transaction between the merchant system 102 and the user 100. This may be in the form of a transaction authorization request to request further processing of a transaction initiated with the portable financial device. The merchant system 102 may communicate user transaction data to the transaction processing server processor 106. The user transaction data may include transaction parameters associated with transactions initiated with the portable financial device of the user 100. Non-limiting examples of transaction parameters include: primary account number (PAN), transaction amount, transaction date and time, conversion rate of currency, merchant type, acquiring institution country, PAN country, response code, merchant name/location, type of currency, and the like. Response code may refer to a successful approval/completion of a transaction, denial because card reported as lost or stolen, do not honor, partial approval, VIP approval (VIP program), amount exceeds maximum, insufficient funds, incorrect PIN, suspected fraud, activity amount exceeded, allowable number of PIN-entry tries exceeded, and the like. Other relevant response codes from the credit card issuer response codes may be included as the response code, where relevant. Further, it will be appreciated that these transaction parameters associated with transactions of the user 100 may be communicated to the transaction processing server processor 106.

The transaction processing server processor 106 may generate further transaction parameters based on the transaction parameters communicated to the transaction processing server processor 106 by the merchant system 102. These transaction parameters may include: duration portable financial device active, average monthly spend, maximum monthly spend, minimum monthly spend, frequency of use, card-based currency, geographical location, total number of transactions outside a first region, average number of transactions outside the first region over a period of time, average spend amount per transaction outside the first region, spending habits, and transaction analysis. Transaction analysis may refer to an analysis of the response codes returned for transactions imitated by the user 100. This may include factors such as, total number of time credit limit exceeded, average number of times credit limit exceeded during a time period (e.g., a year), total number of declines, average number of declines over the time period, number of times card blocked, number of times incorrect PIN entered. The transactions service provider processor 106 may receive and/or determine further transaction parameters associated with each of its users and store them in the transaction processing server database 108.

With continued reference to FIG. 1, the transaction processing server processor 106 may communicate with an issuer system 110 operated by or on behalf of the issuer of the portable financial device. The transaction processing server processor 106 may communicate with the issuer system 110 to obtain authorization for the transaction associated with the transaction authorization request from the merchant system 102. The issuer system 110 may communicate a reply to the transaction processing server processor 106 that the transaction is approved or denied. The transaction processing server processor 106 may, in turn, reply to the transaction authorization request by communicating to the merchant system 102 whether the issuer system 110 approved or denied the transaction.

With continued reference to FIG. 1, based at least in part on the transaction parameters, the transaction processing server processor 106 may determine a supplemental credit metric of the user 100. Thus, the supplemental credit metric may be based on individual transactions initiated by the user 100 using their portable financial device. The supplemental credit metric may be based on all portable financial devices used by the user 100 or all portable financial devices used by the user 100 that are associated with the transaction processing server processor 106.

The supplemental credit metric may consider all portable financial devices, regardless of the region in which the portable financial device was issued. A region may be a geographical region, such as a country or any other definable region. For example, the user may be or have been a holder of portable financial devices based in more than one region. This may be the case, for example, when the user 100 has moved from one country to another. In this example, the user 100 may have originally lived in Singapore (a first region) and held portable financial devices issued by or on behalf of issuers in Singapore and then moved to the United States (a second region) and held portable financial devices issued by or on behalf of issuers in the United States. Thus, the supplemental credit metric may not be limited to user transaction history in a single region and may be based on the user's 100 entire transaction history using their various portable financial devices.

This supplemental credit metric may be distinguishable from credit reports and/or credit scores historically determined by credit bureaus. The credit scores and reports from the credit bureaus do not consider the transaction parameters, including the individual transactions initiated by users using portable financial devices. They also do not consider the spending habits of users using portable financial devices. Further, the credit bureaus do not consider individual transactions initiated by users using portable financial devices issued by issuers based in a region different from the region in which the credit bureau is based. For example, a credit bureau based in the United States may consider credit history of the user for transaction history in the United States (from portable financial devices issued by issuers in the United States) but not in a different region, such as Singapore. Thus, the credit report or credit score issued by a credit bureau for a user who has recently moved to the same region as the credit bureau from a different region would not have their credit history for the different region considered and would start with a minimum or lower than deserved credit score and report.

With continued reference to FIG. 1, the transaction processing server processor 106 may determine the supplemental credit metric for the user 100 as described above. The supplemental credit metric may be a number or grade based on a number scale or grade scale that indicates the user's 100 creditworthiness based partially on the transaction parameters. In some embodiments or aspects, the supplemental credit metric may be on a scale of 0-100 with higher values indicating a higher level of creditworthiness. However, it will be appreciated that any other scale may be used for the supplemental credit metric.

With continued reference to FIG. 1, the transaction processing server processor 106 may communicate with a computing device 116 of the user 100 to provide the user 100 with their supplemental credit metric. The transaction service provider 106 may communicate the supplemental credit metric to the user's computing device 116 periodically, such as daily, weekly, monthly, quarterly, yearly, or combinations thereof. The transaction service provider 106 may communicate the supplemental credit metric to the user's computing device 116 based on a request message communicated to the transaction processing server processor 106 from the user's computing device 116 or other entity's computing device. The request message may be a transaction authorization request from the merchant system 102 (also a computing device) for a transaction, after which the transaction processing server processor 106 communicates the supplemental credit metric to the user's computing device 116, such that the user's computing device 116 receives the supplemental credit metric following each transaction initiated using their portable financial device. The request message may be from the issuer system 110 or other entity (such as the later described credit bureau system) (computing devices). The computing device 116 may be associated with an issuer in the first region, such that the issuer system 110 receives user transaction data associated with a portable financial device issued by or on behalf of an issuer outside the first region. The user computing device 116 may also communicate a direct request message to the transaction processing server processor 106 to receive their supplemental credit metric. This may allow the user 100 to closely track their supplemental credit metric. Requesting the updated supplemental credit metric may not adversely impact the user's 100 supplemental credit metric from the transaction service provide processor 106 or the user's 100 other credit scores, such as from credit bureaus. Such communication from the transaction processing server processor 106 to the user's computing device 116 may include a web-based communication, an email communication, a text message, a telephone call, a push notification, and/or an instant message. The user's computing device 116 may also communicate with the transaction processing server processor 106 using like communication methods.

With continued reference to FIG. 1, the transaction processing server processor 106 may initiate a target activity, such as by communicating to the user computing device 116, based partially on the supplemental credit metric of the user 100. The target activity may include communicating an offer to the user computing device 116 for users having a certain supplemental credit metric or falling within a supplemental credit metric range. The offer may be related to a transaction activity offered by the transaction service provider or another financial institution having a business relationship with the transaction service provider. For example, the transaction processing server processor 106 may communicate an offer to the user computing device 116 for a certain credit card (e.g., a VIP credit card) for all users having a supplemental credit metric over a certain value. In some non-limiting embodiments or aspects, the target activity may be communicated by the financial institution system/issuer system 110/114 based on the supplemental credit metric of the user 100. In some non-limiting embodiments or aspects, the target activity may include automatically enrolling all users having a certain supplemental credit metric or in a certain supplemental credit metric range in a rewards program. Other target activities may be communicated to the user computing device 116 based on the supplemental credit metric of the user 100.

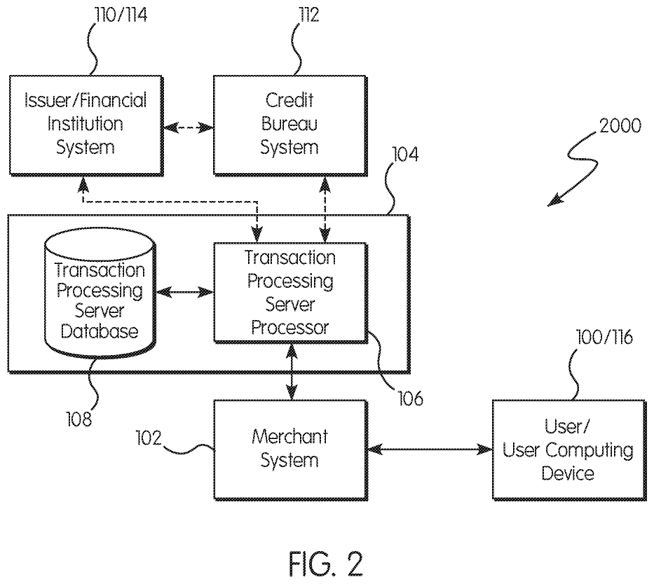

Referring to FIG. 2, a non-limiting embodiment or aspect of a system 2000 of determining a supplemental credit metric based on transaction data of a user 100 is shown. The system of FIG. 2 may include all of the features of the system 1000 of FIG. 1 having like reference numbers. In some non-limiting embodiments or aspects, a credit bureau system 112 (also a computing device) associated with a credit bureau may communicate with the transaction processing server processor 106 to request the supplemental credit metric for the user 100. The credit bureau system 112 may determine an initial credit score for the user 100, which is not based on the transaction parameters. This credit score may not be based on individual transactions initiated by the user 100 using their portable financial device. After receiving the supplemental credit metric, the credit bureau system 112 may determine a revised credit score that considers its initial credit score and the supplemental credit metric. This revised credit score may more accurately reflect the creditworthiness of the user 100 compared to the initial credit score.

With continued reference to FIG. 2, a financial institution system 114 (also a computing device) may communicate with the credit bureau system 112. The financial institution system 114 may be the same as the issuer system 110 in the case in which the financial institution is the issuer. However, the financial institution may be an entity other than the issuer. The financial institution system 114 may communicate with the credit bureau system 112 to request a credit score regarding the user 100. This request may be in connection with a request made to the financial institution system 114 by the user 100 to initiate a transaction activity, such as a mortgage, a personal loan, various other types of loans, or to issue a credit card.

The financial institution system 114 may request the credit score for the user 100 from the credit bureau system 112 so that the financial institution system 114 may determine whether to approve or deny the user's 100 request for the transaction activity, and other details regarding the transaction activity, such as, amount of the loan/mortgage, duration of the loan/mortgage, interest rate associated with the loan/mortgage, type of credit card to issue, interest rate associated with the credit card, credit limit on the credit card, and the like.

In response to the request from the financial institution system 114, the credit bureau system 112 may communicate the revised credit score as the credit score provided to the financial institution system 114 such that the financial instruction processor 114 uses the more comprehensive credit score considering the transaction parameters in its determinations relative to the transaction activity requested by the user 100 (e.g., initiating or not initiating the transaction activity based partially on the supplemental credit metric). The credit bureau system 112 may be operated by or on behalf of a credit bureau located in a first region, while the supplemental credit metric received from the transaction service provider processor 106 may be based partially on transaction parameters from a portable financial device of the user 100 that was issued by or on behalf of an issuer outside the first region.

With continued reference to FIG. 2, in some non-limiting embodiments or aspects, the financial institution system 114 may communicate directly with the transaction processing server processor 106 to receive the supplemental credit metric for the user 100 via a request, as opposed to receiving a revised credit score from the credit bureau system 112. The financial institution system 114 may use the supplemental credit metric received from the transaction service provider processor 106 in its determinations relative to the transaction activity requested by the user 100 (e.g., initiating or not initiating the transaction activity based partially on the supplemental credit metric). The financial institution system 114 may be operated by or on behalf of a financial institution located in a first region, while the supplemental credit metric received from the transaction service provider processor 106 may be partially based on transaction parameters from a portable financial device of the user 100 that was issued by or on behalf of an issuer outside the first region.

With continued reference to FIG. 2, the transaction processing server processor 106 may communicate product recommendations to the financial institution system 114 so that the financial institution system 114 may recommend products to the user 100. These product recommendations may be based on the revised credit score or the supplemental credit metric communicated to the financial institution system 114 for the user 100. For example, for users applying for a credit card, the transaction processing server processor 106 may generate and communicate a product recommendation to the financial institution system 114 associated with credit cards suitable for the user 100 based on the revised credit score or the supplemental credit metric. This product recommendation may be made based on the products used by other users having a similar revised credit score or supplemental credit metric. The product recommendation may be based on a machine learning algorithm that analyzes products used by other users having a similar revised credit score or supplemental credit metric.

With continued reference to FIG. 2, the transaction processing server processor 106 may communicate service recommendations to the financial institution system 114 so that the financial institution system 114 may determine which services to offer the user 100. These service recommendations may be based on the revised credit score or the supplemental credit metric communicated to the financial institution system 114 for the user 100. For example, for users applying for a credit card, the transaction processing server processor 106 may generate and communicate a service recommendation to the financial institution system 114 of what services to offer with the credit card offered to the user 100 based on the revised credit score or the supplemental credit metric. This service recommendation may be made based on the services used by other users having a similar revised credit score or supplemental credit metric. The service recommendation may be based on a machine learning algorithm that analyzes services used by other users having a similar revised credit score or supplemental credit metric.

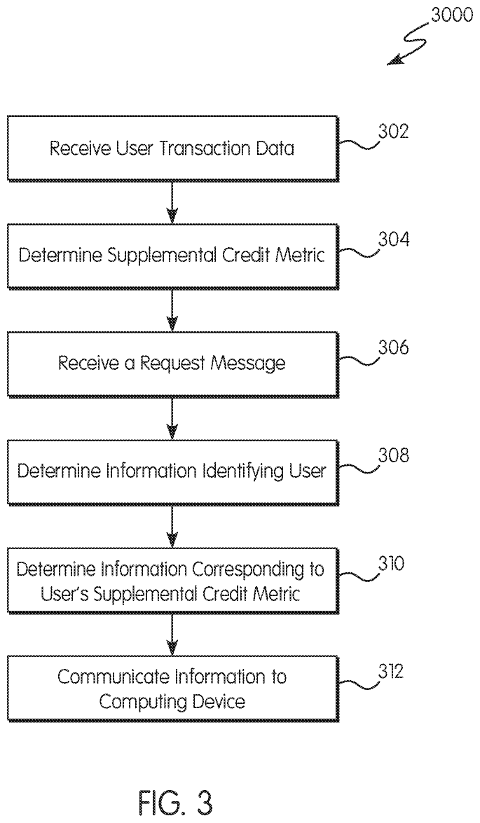

Referring to FIG. 3, a method 3000 of determining a supplemental credit metric based on transaction data of a user is shown. At a step 302, at least one processor, may receive user transaction data including transaction parameters associated with transactions initiated with a portable financial device of the user 100. The merchant system 102 may communicate the user transaction data including the transaction parameters previously listed to the transaction processing server processor 106. From this communication, the transaction service provide processor 106 may further determine the previously discussed transaction parameters. The transaction parameters may be associate with transactions initiated with portable financial devices of the user 100, regardless of the country in which the issuer issuing the portable financial device is based so that the transaction processing server processor 106 receives relevant user transaction data over the user's 100 entire transaction history. The transaction processing server processor 106 may receive the user transaction data from the merchant system 102 using any of the example systems (e.g., system 1000 and system 2000) described above or any other system consistent with the present invention.

With continued reference to FIG. 3, at a step 304, at least one processor may determine a supplemental credit metric of the user 100 based at least partially on the transaction parameters. The transaction processing server processor 106 may determine the supplemental credit metric for the user based on the transaction parameters received from the merchant systems 102. The transaction processing server processor 106 may determine the supplemental credit metric for the user 100 using any of the example systems (e.g., system 1000 and system 2000) described above or any other system consistent with the present invention.

With continued reference to FIG. 3, at a step 306, at least one processor, may receive a request message, the request message including information associated with the user 100. At a step 308, at least one processor, may determine information identifying the user 100 based on the information included in the request message. The information associated with the user 100 may include information that allows the transaction processing server processor 106 to identify the user 100 who is the subject of the request message. In other words, based on the information associated with the user 100 in the request message, the transaction processing server processor 106 may determine the user 100 that is the subject of the request message. For example, this information associated with the user 100 may include at least one of: user's name, user's address, PAN number associate with user's portable financial device, other account number of the user, user's social security number, log-in information for a user account (e.g., username, password, pin number, answer to security questions, and the like), and the like. The request message may be a message requesting the supplemental credit metric of the user 100. The request message may be communicated to the transaction processing server processor 106 from the user's computing device 116. The request message may be communicated to the transaction processing server processor 106 from the credit bureau system 112. The request message may be communicated to the transaction processing server processor 106 from the financial institution system 114. The request message may be communicated to the transaction processing server processor 106 from the merchant system 102 along with a transaction authorization request. The transaction processing server processor 106 may receive information identifying the user 100 and determine information identifying the user 100 based on the information included in the request message using any of the example systems (e.g., system 1000 and system 2000) described above or any other system consistent with the present invention.

With continued reference to FIG. 3, at a step 310, at least one processor may determine information corresponding to the supplemental credit metric of the user 100. The transaction processing server processor 106 may associate the supplemental credit metric for the user 100 with the user 100 that is the subject of the request message. At a step 312, at least one processor, may communicate the information corresponding to the supplemental credit metric of the user to a computing device. The transaction processing server processor 106 may communicate the supplemental credit metric to the user computing device 116. The transaction processing server processor 106 may communicate the supplemental credit metric to the credit bureau system 112. The transaction processing server processor 106 may communicate the supplemental credit metric to the financial institution system 114. The transaction processing server processor 106 may determine information corresponding to the supplemental credit metric of the user 100 and communicate the information corresponding to the supplemental credit metric to the computing device using any of the example systems (e.g., system 1000 and system 2000) described above or any other system consistent with the present invention.

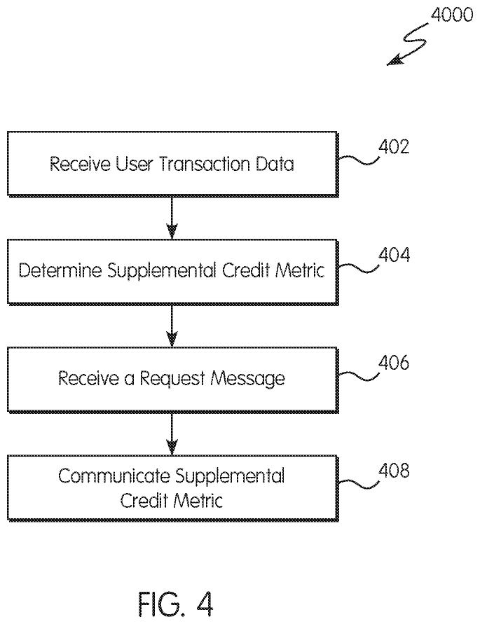

Referring to FIG. 4, a method 4000 of determining a supplemental credit metric based on transaction data of a user is shown. At a step 402, at least one processor may receive user transaction data including transaction parameters associated with transactions initiated with a plurality of portable financial devices of a user, wherein at least two of the portable financial devices were issued by or on behalf of issuers in different regions from one another. The transaction service provide processor 106 may receive transaction data from a plurality of portable financial devices held by the user 100. Two of the portable financial devices may be issued by issuers located in different regions (e.g., issuers located in different countries). Thus, the portable financial devices may be based out of different countries. For example, one of the portable financial devices may have been issued by an issuer located in Singapore, while another of the portable financial devices may have been issued by an issuer located in the United States. The transaction processing server processor may receive user transaction data including transaction parameters associated with transactions initiated with a plurality of portable financial devices of a user, where at least two of the portable financial devices were issued by or on behalf of issuers in different regions from one another using any of the example systems (e.g., system 1000 and system 2000) described above or any other system consistent with the present invention.

With continued reference to FIG. 4, at a step 404, at least one processor may determine a supplemental credit metric of the user 100 based at least partially on the transaction parameters. Step 404 of the method 4000 may be the same as step 304 of the method 3000. At a step 406, at least one processor may receive a request message from a computing device, the request message associated with the user 100. Step 406 of the method 4000 may be the same as step 306 of the method 3000.

With continued reference to FIG. 4, at a step 408, at least one processor may communicate the supplemental credit metric of the user 100 to the computing device. The transaction processing server processor 106 may communicate the supplemental credit metric for the user 100 determined in step 404 and communicate the supplemental credit metric to a computing device. The computing device may be the user computing device 116, the credit bureau system 112, and/or the financial institution system 114.

### EXAMPLES

The following examples are provided to illustrate embodiments or aspects of the system and method for determining a supplemental credit metric and are not meant to be limiting.

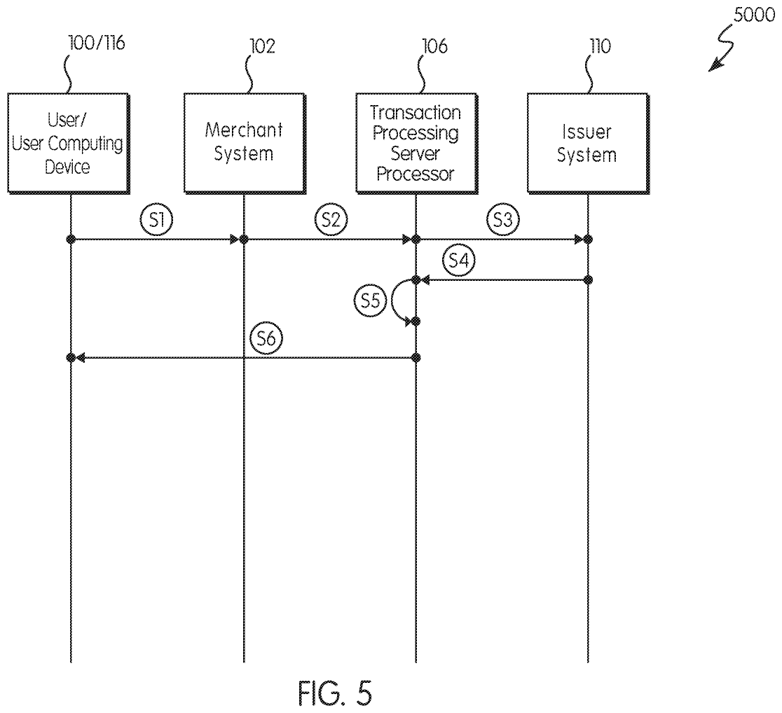

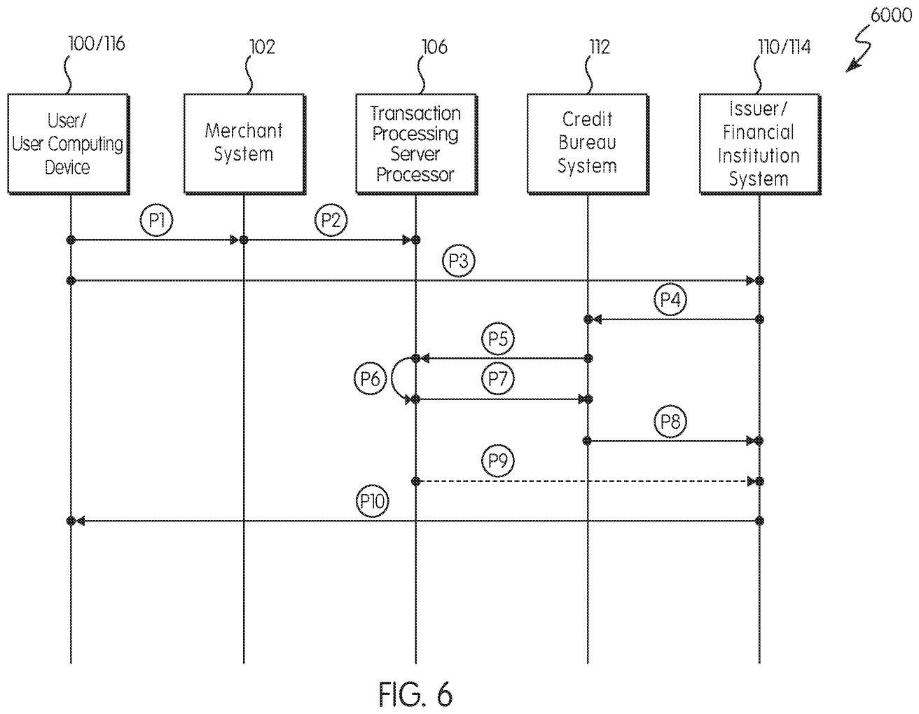

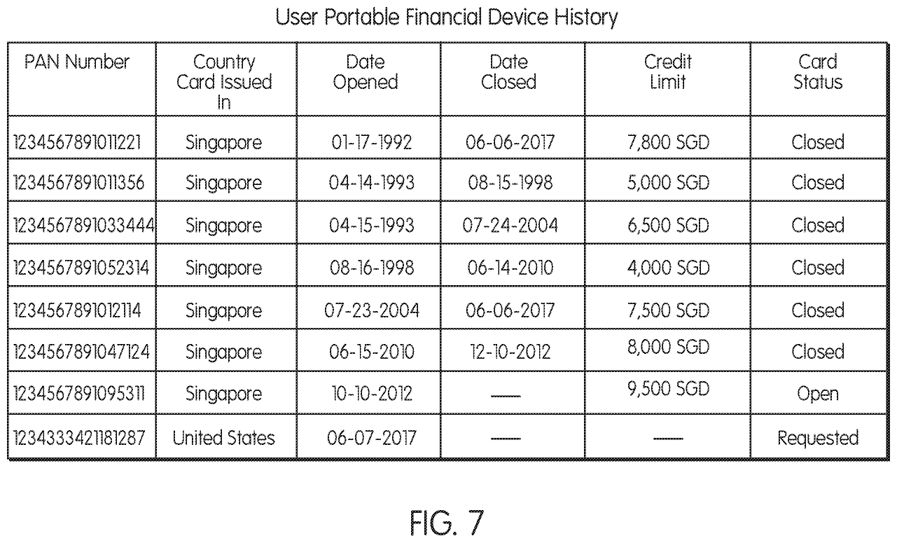

Referring to FIGS. 5 and 6, non-limiting examples of methods 5000, 6000 of determining a supplemental credit metric based on transaction data of a user are shown. In these examples, John Smith is a user of a plurality of portable financial devices and uses these portable financial devices to initiate transactions, such as with a merchant system. John Smith lived in Singapore (a first region) until June 2017, but recently moved to the United States (a second region). John Smith has a lengthy credit history and has been a credit card (portable financial device) holder since 1992. He has never missed a payment and has used his credit cards responsibly. While living in Singapore, he had an excellent credit score, as determined by a credit bureau based in Singapore using traditional methods of determining credit score (e.g., without evaluating individual transactions of his portable financial devices). FIG. 7 shows John Smith's history as a credit card holder. He previously held credit cards issued by an issuer located in Singapore. Many of these credit cards have been closed, but he still has one such credit card open while he transitions to moving to the United States. He has applied for a new credit card from a issuer located in the United States, and the status of that card is pending (e.g., the issuer is determining whether to issue John Smith a credit card and with what credit limit and interest rate).

### Example 1

Referring to FIG. 5, at a first step (s1), John Smith initiates transactions with various merchants (e.g., Merchant A, Merchant B, etc.) using his credit cards to initiate the transaction with the merchant systems. John Smith may use his computing device to initiate his credit card transactions with the Merchant system. The transactions may be for goods or services of the merchant.

At a second step (s2) the merchant systems communicate with the transaction processing server processor of the credit card used. This communication includes a request message that is a transaction authorization request, in order to further process the transaction between John Smith and the merchant systems. The transaction authorization request includes user transaction data including the previously described transaction parameters. The transaction processing server processor determines further transaction parameters, as previously described, based on the transaction parameters received from the merchant systems.

At a third step (s3), the transaction processing server processor communicates with the issuer process or the issuer of the credit card used by John Smith to initiate the transaction. This communication includes information from the transaction authorization request, and the request is made to request approval or denial of the transaction between John Smith and the merchant system. At a fourth step (s4), the issuer system communicates a response to the transaction processing server processor regarding whether the transaction between John Smith and the merchant system is approved or denied.

At a fifth step (s5), the transaction processing server processor determines a supplemental credit metric of John Smith. The supplemental credit metric is determined by the transaction processing server processor as previously described. The determination of the supplemental credit metric analyzes individual transactions initiated by John Smith using his credit cards (e.g., historical credit card transactions), including the transaction that was approved or denied by the issuer system in the fourth step (s4). The determination of the supplemental credit metric for John Smith may be initiated after receiving a request from John Smith's computing device or automatically based on the initiation of a credit card transaction by John Smith.

As one example, the supplemental credit metric (SCM) may be determined using the following Formula 1:

$$SCM = α \frac{Ta * ICSa}{Da} + β \frac{Tb * ICSb}{Db} + γ \frac{Tc * ICSc}{Dc} + …$$

In Formula 1, α, β, and γ are constants. ICSₓ is the individual card score determined for credit card x. ICSₓ may be determined based at least partially on the previously discussed transaction parameters associated with card x. Tₓ is the time in years John Smith had the card account for card x open. Dₓ is the number of declines for card x. To calculate John Smith's SCM, each of his credit cards listed in FIG. 7, or some subset of that list, may be included. It will be appreciate that other Formulas may be used to determine the supplemental credit metric.

At a sixth step (s6), the transaction processing server processor communicates with John Smith's computing device, such as transmitting an electronic communication to John Smith's computing device. The communication includes an update regarding John Smith's supplemental credit metric. The communication includes John Smith's most recent supplemental credit metric: such as “your supplemental credit metric is ‘89’”. The communication may include an update regarding a change in John Smith's supplemental credit metric, such as an increase or decrease in supplemental credit metric based on a recent transaction. Such communication may read “based on your recent purchase of $100.00 from Merchant A, your supplemental credit metric increased from ‘88’ to ‘89’”. The transaction processing server processor may also include a suggested target activity, generated based on John Smith's supplemental credit metric. The target activity may be an offer for a VIP credit card based on achieving an excellent supplemental credit metric, or any other offer in connection with the supplemental credit metric.

### Example 2

Referring to FIG. 6, at a first step (p1), John Smith initiates transactions with various merchants (e.g., Merchant A, Merchant B, etc.) using his credit cards to initiate the transaction with the merchant systems. This first step (p1) is identical to the first step (s1) in the method 5000 of FIG. 5. At a second step (p2) the merchant systems communicate with the transaction processing server processor. This second step (p2) is identical to the second step (s2) in the method 5000 of FIG. 5.

At a third step (p3), John Smith (e.g., his computing device), communicates a request to a financial institution system (which may be the issuer system in the case that the financial institution is the issuer). The financial institution is First Bank. The financial institution system is managed by or on behalf of a First Bank. John Smith's request is for a transaction activity, as previously described, such as John Smith requesting a credit card from First Bank or a personal loan or mortgage from First Bank.

Upon receipt of John Smith's request for the transaction activity, at a fourth step (p4), First Bank's processor communicates a request to a credit bureau system of First Credit Bureau (e.g., a credit bureau) to request a credit score for John Smith. First Credit Bureau's system may generate a credit score for John Smith using traditional methods which do not analyze individual purchases of John Smith initiated using his credit cards.

At a fifth step (p5), First Credit Bureau's system communicates a request to the transaction processing server processor to request a supplemental credit metric for John Smith, which does analyze individual purchases of John Smith initiated using his credit cards. At a sixth step (p6) the transaction processing server processor determines a supplemental credit metric of John Smith. The supplemental credit metric is determined by the transaction processing server processor as previously described. The determination of the supplemental credit metric analyzes individual transactions initiated by John Smith using his credit cards (e.g., historical credit card transactions).

At a seventh step (p7), the transaction processing server processor communicates with First Credit Bureau's system to fulfill its request. The transaction processing server processor communicates John Smith's supplemental credit metric to First Credit Bureau's system. In response, First Credit Bureau's system may determine a revised credit score based at least partially on the initial credit score it determined and the supplemental credit metric. At an eighth step (p8), First Credit Bureau's system communicates a response to First Bank's processor including the revised credit score for John Smith.

At a ninth step (p9), the transaction processing server processor may communicate product and/or service recommendation to First Bank's processor. The product and/or service recommendation is based on the supplemental credit metric and/or the revised credit score of John Smith and is a recommendation of products and/or services to offer John Smith based on his supplemental credit metric and/or revised credit score. The product and/or service recommendation may be based on products and/or services offered to or used by other individuals with a similar supplemental credit metric and/or revised credit score.

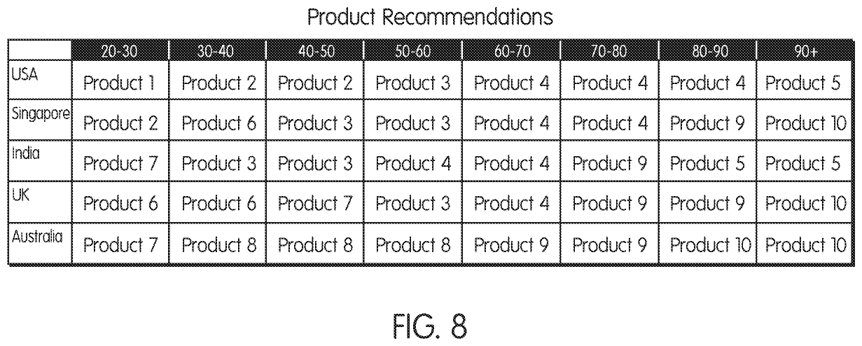

Referring to FIG. 8, an example of product recommendations made by the transaction processing server processor to First Bank's processor is shown. In this example, based on the country in which the individual is located and their supplemental credit metric, a certain product (such as a type of credit card) is offered. For example, for John Smith, who now lives in the USA and has a supplemental credit metric of 89, the transaction processing server processor may communicate a recommendation to First Bank of offering John Smith the credit card corresponding to Product 4 (of Products 1-10 available).

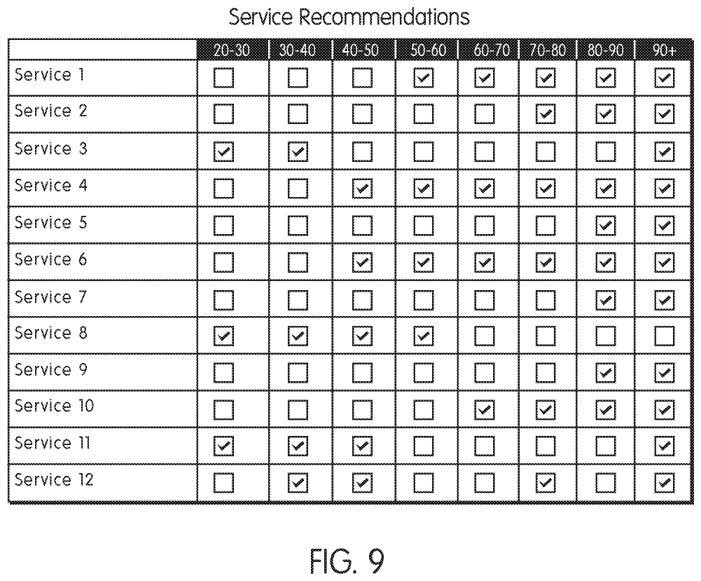

Referring to FIG. 9, an example of service recommendations made by the transaction processing server processor to First Bank's processor is shown. The services may be benefits associated with using a credit card or other product. In this example, based on the individual's supplemental credit metric, a certain service recommendation is offered. For example, for John Smith, who has a supplemental credit metric of 89, the transaction processing server processor may communicate a recommendation of offering John Smith a credit card that has the following services: Service 1, Service 2, Services 4-7, Service 9, and Service 10.

Referring back to FIG. 6, at a tenth step (p10), First Bank's processor determines whether to accept or deny John Smith transaction activity request. If it determines John Smith's request is accepted, it further determines specifics regarding the request. For example, for a credit card request, First Bank's processor determines the type of credit card to offer and the interest rate to offer. For example, for a loan request, First Bank's processor determines the loan amount, loan term, and interest rate to offer. First Bank's processor communicates to John Smith (or his computing device) whether the transaction activity request has been accepted or denied, and the details of the acceptance, if applicable.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method of determining a supplemental credit metric based on transaction data of a user, comprising:
receiving, with at least one processor, user transaction data comprising transaction parameters associated with transactions initiated with a portable financial device of a user;
determining, with at least one processor, a supplemental credit metric of the user based at least partially on the transaction parameters;
receiving, with at least one processor, a request message, wherein the request message comprises information associated with the user;
determining, with at least one processor, information identifying the user based on the information included in the request message;
determining, with at least one processor, information corresponding to the supplemental credit metric of the user; and
communicating, with at least one processor, the information corresponding to the supplemental credit metric of the user to a computing device.

2. The method of claim 1, wherein the request message is received from the computing device.

3. The method of claim 1, wherein the request message is a transaction authorization request for a transaction initiated with the portable financial device of the user.

4. The method of claim 1, wherein the information corresponding to the supplemental credit metric of the user is communicated to the computing device upon initiation of a transaction by the user using the portable financial device.

5. The method of claim 1, wherein the request message is received from the computing device, wherein the computing device is associated with an issuer in the first region, wherein the portable financial device of the user was issued by or on behalf of an issuer outside the first region.

6. The method of claim 1, further comprising:
generating, with at least one processor, a credit score corresponding to the user; and
generating, with at least one processor, a revised credit score based at least partially on the credit score and the supplemental credit metric.

7. (canceled)

8. (canceled)

9. The method of claim 1, further comprising generating a credit score corresponding to the user based at least partially on the supplemental credit metric.

10. The method of claim 1, further comprising at least one of generating and communicating a product or service recommendation to the computing device based at least partially on the supplemental credit metric.

11. (canceled)

12. The method of claim 1, further comprising initiating a transaction activity based at least partially on the supplemental credit metric.

13. The method of claim 1, further comprising initiating a target activity based at least partially on the supplemental credit metric.

14. A system of determining a supplemental credit metric based on transaction data of a user, comprising at least one server computer including at least one processor, the at least one server computer programmed and/or configured to:
receive user transaction data comprising transaction parameters associated with transactions initiated with a portable financial device of a user;
determine a supplemental credit metric of the user based at least partially on the transaction parameters;
receive a request message, wherein the request message comprises information associated with the user;
determine information identifying the user based on the information included in the request message;
determine information corresponding to the supplemental credit metric of the user; and
communicate the information corresponding to the supplemental credit metric of the user to a computing device.

15. The system of claim 14, wherein the request message is received from the computing device.

16. The system of claim 14, wherein the request message is a transaction authorization request for a transaction initiated with the portable financial device of the user.

17. The system of claim 14, wherein the information corresponding to the supplemental credit metric of the user is communicated to the computing device upon initiation of a transaction by the user using the portable financial device.

18. The system of claim 14, wherein the request message is received from the computing device, wherein the computing device is associated with an issuer in the first region, wherein the portable financial device of the user was issued by or on behalf of an issuer outside the first region.

19. The system of claim 14, wherein the at least one server computer is further programmed and/or configured to:
generate a credit score corresponding to the user; and
generate a revised credit score based at least partially on the credit score and the supplemental credit metric.

20. (canceled)

21. (canceled)

22. The system of claim 14, wherein the at least one server computer is further programmed and/or configured to generate a credit score corresponding to the user based at least partially on the supplemental credit metric.

23. The system of claim 14, wherein the at least one server computer is further programmed and/or configured to generate and/or communicate a product or service recommendation to the computing device based at least partially on the supplemental credit metric.

24. (canceled)

25. The system of claim 14, wherein the at least one server computer is further programmed and/or configured to initiate at least one of a transaction activity and a target activity based at least partially on the supplemental credit metric.

26. (canceled)

27. A method of determining a supplemental credit metric based on transaction data of a user, comprising:
receiving, with at least one processor, user transaction data comprising transaction parameters associated with transactions initiated with a plurality of portable financial devices of a user, wherein at least two of the portable financial devices were issued by or on behalf of issuers in different regions from one another;
determining, with at least one processor, a supplemental credit metric of the user based at least partially on the transaction parameters;
receiving, with at least one processor, a request message from a computing device, the request message associated with the user; and
communicating, with at least one processor the supplemental credit metric of the user to the computing device.
